(19) United States
(12) Patent Application Publication
(10) Pub. No.: US 2011/0105003 A1
(43) Pub. Date: May 5, 2011

(54) AIR CONDITIONING SYSTEM FOR ELECTRIC VEHICLE AND METHOD FOR CONTROLLING THE SAME

(75) Inventors: Hee Sang Park, Hwaseong (KR); Hyun Kim, Hwaseong (KR); June Kyu Park, Hwaseong (KR); Jung Hwan Yun, Seoul (KR); Hun Soo Kim, Hwaseong (KR); Hee Jun Jeong, Hwaseong (KR)

(73) Assignee: HYUNDAI MOTOR COMPANY, Seoul (KR)

(21) Appl. No.: 12/752,685

(22) Filed: Apr. 1, 2010

(30) Foreign Application Priority Data
Nov. 4, 2009 (KR) 10-2009-0105723

(51) Int. Cl. B60H 1/00; B60H 1/22; B60H 1/34

(52) U.S. Cl. 454/75; 454/159; 454/155

(57) ABSTRACT

The present invention provides an air conditioning system for an electric vehicle and a method for controlling the same in which heat generated from a drive motor during vehicle running is used to assist the heating of a vehicle interior so as to provide more efficient heating of the vehicle interior and, especially, reduce the amount of battery power consumed for the heating of the vehicle interior, thus increasing driving distance and improving fuel efficiency. The air conditioning system of the invention can cool the drive motor, heat the vehicle interior using waste heat of the drive motor, and purify the air supplied to the vehicle interior with the use of a single blower.

For this purpose, the present invention provides an air conditioning system for an electric vehicle, the air conditioning system including: a blower for blowing air; a drive motor configured to receive the air blown by the blower; an air purification system for purifying the air blown by the blower and supply the purified air to a vehicle interior; a second valve for supplying the air blown by the blower to the drive motor and the air purification system, respectively; and a third valve for supplying the air passing through the drive motor to the outside of the vehicle or to the air purification system, wherein the air passing in turn through the drive motor and the air purification system is supplied to the vehicle interior, thus heating the vehicle interior.

### CROSS-REFERENCE TO RELATED APPLICATION

This application claims under 35 U.S.C. §119(a) the benefit of Korean Patent Application No. 10-2009-0105723 filed Nov. 4, 2009, the entire contents of which are incorporated herein by reference.

### BACKGROUND

(a) Technical Field

The present disclosure relates, generally, to an air conditioning system for an electric vehicle. More particularly, the present invention relates to an air conditioning system for an electric vehicle and a method for controlling the same, which can provide efficient heating of the interior of an electric vehicle driven by electrical energy and, particularly, reduce the amount of battery power consumed for the heating of the vehicle interior, thus increasing driving distance and improving fuel efficiency.

(b) Background Art

Gasoline engines and diesel engines, which consume fossil fuel, have certain problems such as environmental contamination due to exhaust gas, global warming due to carbon dioxide, respiratory ailments due to increased ozone, etc. Moreover, since the amount of fossil fuel left on the earth is limited, it will be exhausted in the near future.

Accordingly, various types of electric vehicles, such as a pure electric vehicle (EV) driven by operating a drive motor, a hybrid electric vehicle (HEV) driven by an engine and a drive motor, a fuel cell electric vehicle (FCEV) driven by operating a drive motor using electric power generated by a fuel cell, etc., have been developed to address the above issues.

Electric vehicles preferably include a drive motor for driving the vehicle, a battery as an energy storage device for supplying electric power to the drive motor, and an inverter for rotating the drive motor. Preferably, in a fuel cell electric vehicle, an energy storage device such as a battery is used as an auxiliary power source connected in parallel with a fuel cell as a main power source. Further, a fuel cell hybrid system including a supercapacitor as an auxiliary power source in addition to the battery has been developed. The inverter inverts the phase of electric power supplied from the energy storage device (or fuel cell) based on a control signal applied from a controller to operate the drive motor.

Preferably, the electric vehicle includes a heating system for heating the vehicle interior and an air purification system for maintain the vehicle interior air more pleasant and fresh.

As an exemplary heating system of the electric vehicle, a heating system which uses the power of the battery may be used. An example of such a heating system is a positive temperature coefficient (PTC) heater, which is used as an auxiliary heating system to complement the heating performance of the vehicle in the existing gasoline (or diesel) vehicles.

However, when the heating system (e.g., PTC heater) is used to heat the interior air of the electric vehicle driven by the electrical energy stored in the battery, the electric power of the battery is consumed, and thus the running distance of the vehicle is reduced. Moreover, in the case of the fuel cell electric vehicle, the excessive power consumption for heating the vehicle interior also reduces the fuel efficiency.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

IN preferred aspects, the present invention features an air conditioning system for an electric vehicle and a method for controlling the same in which heat generated from a drive motor during vehicle running is preferably used to assist the heating of a vehicle interior so as to provide more efficient heating of the vehicle interior and, preferably, reduce the amount of battery power consumed for the heating of the vehicle interior, thus suitably increasing driving distance and suitably improving fuel efficiency.

In preferred embodiment, the present invention preferably provides an air conditioning system for an electric vehicle, the air conditioning system preferably comprising a blower for blowing air; a drive motor that is suitably configured to receive the air blown by the blower; an air purification system for purifying the air blown by the blower and suitably supply the purified air to a vehicle interior; a second valve for suitably supplying the air blown by the blower to the drive motor and the air purification system, respectively; and a third valve for suitably supplying the air passing through the drive motor to the outside of the vehicle or to the air purification system, wherein the air passing in turn through the drive motor and the air purification system is supplied to the vehicle interior, thus heating the vehicle interior.

In another preferred embodiment, the present invention provides a method for controlling an air conditioning system for an electric vehicle, the method preferably comprising operating a blower for blowing air; cooling a drive motor by suitably supplying the air blown by the blower to the drive motor when the temperature of the drive motor is higher than a first predetermined reference temperature; and suitably heating a vehicle interior by supplying the air heated by the drive motor to the vehicle interior through an air purification system when the interior temperature of the vehicle is lower than a user's desired temperature.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above features and advantages of the present invention will be apparent from or are set forth in more detail in the accompanying drawings, which are incorporated in and form a part of this specification, and the following Detailed Description, which together serve to explain by way of example the principles of the present invention.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram showing an air conditioning system for an electric vehicle according to an exemplary embodiment of the present invention;

FIG. 2 is a block diagram showing a configuration for controlling the air conditioning system according to the present invention; and

FIG. 3 is a schematic diagram showing a configuration in which heat exchange between a drive motor and air is achieved in an exemplary embodiment of the present invention.

Reference numerals set forth in the Drawings includes reference to the following elements as further discussed below:

| | |
|---|---|
| 10: blower | 20: air purification system |
| 30: heating system | 40: drive motor |
| 41: housing | 60: controller |
| 71: first valve | 72: second valve |
| 73: third valve | 74: fourth valve |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

According to certain preferred aspects, the present invention features an air conditioning system for an electric vehicle, the air conditioning system comprising a blower for blowing air, a drive motor, an air purification system, a second valve, and a third valve, wherein the air passing in turn through the drive motor and the air purification system is supplied to the vehicle interior, thus heating the vehicle interior.

In one embodiment, the drive motor is configured to receive the air blown by the blower.

In another embodiment, the air purification system is used for purifying the air blown by the blower and supply the purified air to a vehicle interior.

In another further embodiment, the second valve is used for supplying the air blown by the blower to the drive motor and the air purification system, respectively.

In still another embodiment, the third valve is used for supplying the air passing through the drive motor to the outside of the vehicle or to the air purification system.

In another aspect, the present invention features a method for controlling an air conditioning system for an electric vehicle, the method comprising operating a blower for blowing air, cooling a drive motor by supplying the air blown by the blower to the drive motor, and heating a vehicle interior by supplying the air heated by the drive motor to the vehicle interior.

In one embodiment, the drive motor is cooled when the temperature of the drive motor is higher than a first predetermined reference temperature.

In another embodiment, the vehicle interior is heated through an air purification system when the interior temperature of the vehicle is lower than a user's desired temperature.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention preferably provides an air conditioning system for an electric vehicle, such as, but not limited to, a pure electric vehicle, a hybrid electric vehicle, a fuel cell electric vehicle, etc., driven by operating a drive motor using electric energy stored in a battery or generated by a fuel cell.

In particularly preferred embodiments, the air conditioning system according to the present invention preferably includes a heating system which suitably performs the heating of the vehicle interior using waste heat generated from the drive motor during vehicle running and is effectively used as an auxiliary heating system in winter in an electric vehicle which employs a positive temperature coefficient (PTC) heater or other heating system which can be equipped in the vehicle, or an auxiliary heat exchange system for converting electrical energy into heat energy. Preferably, the air conditioning system of the present invention is suitably provided together with the existing PTC heater or other heating system, or the auxiliary heat exchange system to be effectively used as an auxiliary heating system for heating the vehicle interior.

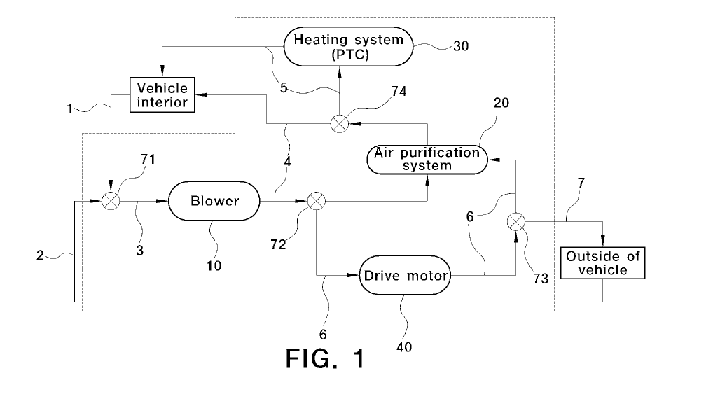

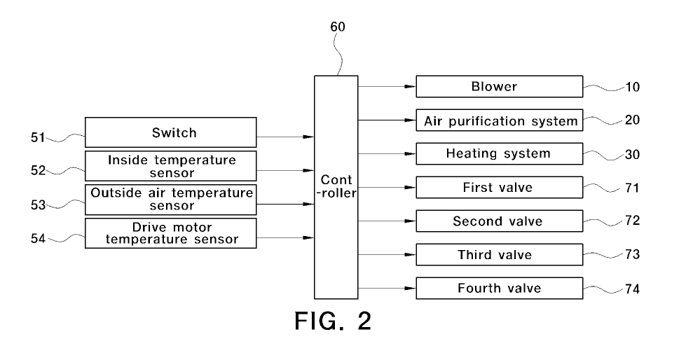

According to certain preferred embodiments of the present invention and as shown in FIG. 1, FIG. 1 is a schematic diagram showing an air conditioning system for an electric vehicle according to an exemplary embodiment of the present invention. FIG. 2 is a block diagram showing a preferred configuration for controlling the air conditioning system according to the present invention.

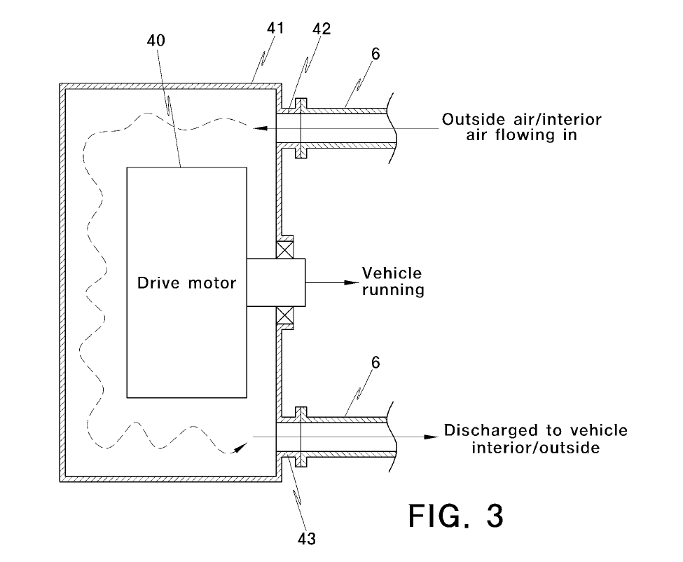

According to other certain preferred embodiments of the present invention and as shown in FIG. 3, FIG. 3 is a schematic diagram showing a preferred configuration in which heat exchange between a drive motor and air is suitably achieved in an exemplary embodiment of the present invention.

According to certain preferred embodiments, the present invention includes a configuration for actively controlling the flow of air passing through a drive motor based on the interior temperature of the vehicle.

In certain preferred embodiments, for example as shown in the figure, the air conditioning system of the present invention preferably includes a blower 10 for blowing the outside air and the vehicle interior air and an air purification system 20 for purifying the air blown by the blower 10 and suitably supplying the purified air into the vehicle interior.

According to further preferred embodiments, the air conditioning system of the present invention preferably includes a heating system 30 for heating the air purified by the air purification system 20 and supplying the heated air into the vehicle interior. Preferably, the heating system 30 may be a positive temperature coefficient (PTC) heater, which is suitably driven by electric power of a battery (not shown) or other heating system, which can be suitably equipped in the vehicle, or an auxiliary heat exchange system for converting electrical energy into heat energy.

According to further preferred embodiments, the heating system 30 is used to supplement the heat of an auxiliary heating system of the present invention which heats the air using waste heat generated from a drive motor 40 during vehicle running and supplies the heated air into the vehicle interior.

Preferably, when the amount of heat emitted from the drive motor 40 is suitably insufficient to heat the vehicle interior because the temperature of the drive motor 40 is not so high, the air heated by the drive motor 40 is further heated by the heating system 30 and suitably supplied to the vehicle interior such that the interior temperature of the vehicle reaches a target heating temperature within a short period of time.

According to further preferred embodiments, the air conditioning system of the present invention preferably includes a vehicle drive motor, i.e., the drive motor 40, driven by receiving the electric power of the battery through an inverter (not shown).

According to further preferred embodiments, the air conditioning system of the present invention includes a plurality of air lines (e.g., air ducts), through which air flows, for example, such as a first air inlet line 1, through which the outside air flows, and a second air inlet line 2, through which the air circulated through the vehicle interior flows, the first air inlet line 1 and the second air inlet line 2 being suitably connected to an inlet of the blower 10 through a common line, i.e., inlet line 3.

According to further preferred embodiments, the air conditioning system of the present invention preferably includes an air supply line 4, through which the air blown by the blower 10 is suitably supplied to the vehicle interior, and the air purification system 20 provided in the middle of the air supply line 4 such that the air blown by the blower 10 is purified by the air purification system 20 and then suitably supplied to the vehicle interior.

According to other further embodiments, the air conditioning system of the present invention includes an air heating line 5 branched from the air supply line 4 at the rear end of the air purification system 20 such that the air purified by the air purification system 20 passes through the heating system 30 and then is suitably supplied to the vehicle interior.

Preferably, the air heating line 5 is suitably connected to the vehicle interior such that the air purified by the air purification system 20 is finally supplied to the vehicle interior, and the heating system 30 is suitably provided in the middle of the air heating line 5.

Accordingly, the air passing through the air purification system 20 and suitably supplied to the air heating line 5 is further heated by the heating system 30 and then suitably discharged to the vehicle interior, thus heating the vehicle interior.

According to further preferred embodiments, a bypass line 6 branched from the air supply line 4 at the front end of the air purification system 20 is suitably connected to the air purification system 20 through the drive motor 40 such that the air blown by the blower 10 and suitably supplied to the bypass line 6 flows through the bypass line 6, passes through the drive motor 40, and then is suitably supplied to the air purification system 20.

Preferably, a duct forming the bypass line 6 and an air passage around the drive motor 40 are suitably configured such that the air flowing through the bypass line 6 and passing through the drive motor 40 is heated by absorbing heat generated from the drive motor 40.

According to further preferred embodiments, an air discharge line 7 branched from the bypass line 6 at the rear end of the drive motor 40 is suitably provided such that the air flowing in the bypass line 6 and passing through the drive motor 40 is suitably discharged to the outside of the vehicle through the air discharge line 7, if necessary.

According to certain preferred embodiments and referring to FIG. 3, for example, a housing 41 is provided to surround the periphery of the drive motor 40 and has an interior space in which heat exchange between the drive motor 40 and the air passing therethrough is made.

In further preferred embodiments, the bypass line 6 at the front end of the drive motor 40 and that at the rear end of the drive motor 40 are suitably connected to an inlet 42 of the housing 41 and an outlet 43 thereof, respectively.

Preferably, the housing 41 is suitably provided around the drive motor 40 to form a gap between the housing 41 and the outer surface of the drive motor 40 such that the air flowing into the interior space of the housing 41 through the bypass line 6 at the front end of the drive motor 40 suitably passes through the gap (i.e., the interior space of the housing 41) between the outer surface of the drive motor 40 and the inner surface of the housing 41 and then is suitably discharged to the outside of the housing 41 through the bypass line 6 at the rear end of the drive motor 40.

While passing through the interior space of the housing 41 (i.e., the gap), the air is heat-exchanged with the drive motor 40 and then suitably discharged to the outside of the housing 41. Preferably, the air absorbs the heat generated from the drive motor 40 during vehicle running and then is suitably discharged to the outside.

Accordingly, the bypass line 6 at the front and rear ends of the drive motor 40 is suitably connected to the interior space of the housing 41 (i.e., the gap) such that the outside air or the vehicle interior air supplied to the interior of the housing 41 through the bypass line 6 at the rear end of the drive motor 40 passes through the periphery of the drive motor 40 and then is suitably discharged through the bypass line 6 at the rear end of the drive motor 40.

According to further preferred embodiments, since the air absorbs waste heat generated from the drive motor 40 during vehicle running while passing through the interior space of the housing 41 and then is discharged from the housing 41, the air is heated by the heat generated from the drive motor 40 while cooling the drive motor 40 and then supplied to heat the vehicle interior.

Referring back to FIG. 1, a plurality of valves for determining the flow direction of air and the air passages are suitably provided. Accordingly, a first valve 71 is suitably provided in a position, where the first and second air inlet lines 1 and 2 are suitably connected to the inlet line 3, to selectively supply the outside air and the vehicle interior air to the blower 10.

In another further embodiment, the first valve 71 is suitably provided at the front end of the blower 10 to selectively supply the outside air introduced from the outside of the vehicle and the vehicle interior air circulated through the vehicle interior to the blower 10.

In other further embodiments, a second valve 72 is suitably provided in a position, where the bypass line 6 is branched from the air supply line 4, to supply the air supplied by the blower 10 to the air purification system 20 and the drive motor 40, respectively. In further related embodiments, a third valve 73 is suitably provided in a position, where the air discharge line 7 is branched from the bypass line 6, to supply the air passing through the drive motor 40 to the air purification system 20 or to the outside of the vehicle.

In addition, a fourth valve 74 is suitably provided in a position, where the air heating line 5 is branched from the air supply line 4, to supply the air passing through the air purification system 20 to the heating system 30 and the vehicle interior, respectively.

Preferably, the first to fourth valves 71 to 74 are electronic valves controlled by control signals applied from a controller 60, and the flow direction of air is determined by the opening degree of the valve. Accordingly, the air passages are determined under the control of the controller 60, which will be described later.

Preferably, each valve is suitably controlled to serve as a switching valve which allows the air to flow in a selected direction or as a distribution valve which properly distributes the amount of air by suitably controlling the opening degree in each direction.

According to certain preferred embodiments, in the air conditioning system of the present invention having the above-described configuration, the controller 60 controls the operation of the blower 10, the air purification system 20, and the heating system 30, and further controls the operation of the first to fourth valves 71 to 74 based on signals from an inside temperature sensor 52, an outside air temperature sensor 53, and drive motor temperature sensor 54, for example as shown in FIG. 2.

Preferably, when receiving a signal for actuating the air purification system 20 from a switch 51 manipulated by a user, the controller 60 suitably operates the blower 10 together with the air purification system 20 and, when receiving a signal for stopping the operation of the air purification system 20, suitably stops the operation of the air purification system 20 and the blower 10.

According to other further preferred embodiments, the controller 60 may suitably control the on/off and the rotational speed (i.e., the amount of air blown) of the blower 10 and the opening degree of each valve based on a detection value of the inside temperature sensor 52 (i.e., the interior temperature of the vehicle), a detection value of the outside air temperature sensor 53 (i.e., the outside air temperature), and a detection value of the drive motor temperature sensor 54 (i.e., the temperature of the drive motor), and may further control the operation of the air purification system 20 and the blower 10 in response to a signal from the switch 51 manipulated by a user.

An example in which the controller 60 controls the air conditioning system of the present invention under the condition that the blower 10 operates according to certain preferred embodiments of the present invention is described.

Preferably, when the temperature of the drive motor 40 as a detection value of the drive motor temperature sensor 54 is higher than a first predetermined reference temperature, the controller 60 controls the valves 71, 72, and 73 such that most of the outside air and the vehicle interior air supplied by the blower 10 are supplied to the drive motor 40, thus cooling the drive motor 40.

According to further exemplary embodiments, since the air passing through the interior of the housing 41 through the bypass line 6 absorbs the heat generated from the drive motor 40, its temperature is suitably higher than that of the vehicle interior air.

Accordingly, when the interior temperature of the vehicle as a detection value of the inside temperature sensor 52 is suitably lower than a user's desired temperature, the controller 60 suitably determines that the heating of the vehicle interior is required, supplies the heated air passing through the drive motor 40 to the air purification system 20, and supplies the heated and purified air passing through the air purification system 20 to the vehicle interior, thus heating the vehicle interior.

According to other further embodiments, in this process, when it is determined that an additional heat source is suitably required based on the current interior temperature of the vehicle and the user's desired temperature, the controller 60 operates the heating system 30 and, at the same time, controls the fourth valve 74 to supply the air passing through the air purification system 20 to the heating system 30 such that the air further heated by the heating system 30 is finally supplied to the vehicle interior. Preferably, if the interior temperature of the vehicle does not reach the user's desired temperature even after a predetermined time, the controller 60 may suitably determine that a further heat source is required.

In other further embodiments, when the temperature of the drive motor 40 is suitably lower than the first reference temperature, the controller 60 controls the valves 71 and 72 to supply most of the air supplied by the blower 10 directly to the air purification system 20, and the air purification system 20 removes dust and odor from the supplied air by a known method using activated carbon and an ion generator and supplies the clean air to the vehicle interior.

Preferably, when it is determined that the heating of the vehicle interior is required as the interior temperature of the vehicle is lower than the user's desired temperature during the process that the air supplied by the blower 10 is directly supplied to the air purification system 20 without passing through the drive motor 40, the controller 60 suitably supplies the air passing through the air purification system 20 to the heating system 30 and suitably supplies the air heated by the heating system 30 to the vehicle interior, thus heating the vehicle interior.

In further preferred embodiments, when it is determined that the heating of the vehicle interior is not required based on the interior temperature of the vehicle, the controller 60 suitably controls the third valve 73 so as not to supply the air passing through the drive motor 40 (i.e., the interior space of the housing 41) to the air purification system 20 but to discharge the air to the outside of the vehicle through the air discharge line 7.

Preferably, the controller 60 suitably discharges the air absorbing the heat emitted from the drive motor 40 while passing therethrough to the outside of the vehicle through the air discharge line, thus cooling the drive motor 40.

Accordingly, in this process, when the interior temperature of the vehicle is suitably higher than a second predetermined reference, the controller 60 suitably controls the first valve 71 to allow the outside air blown by the blower 10 to pass through the drive motor 40, thus cooling the drive motor 40 by the outside air.

As described above, according to the air conditioning system for an electric vehicle and the method for controlling the same of the present invention, since the heat emitted from the drive motor can be used to assist the heating of the vehicle interior, it is possible to provide more efficient heating of the vehicle interior and, in particular, reduce the amount of battery power consumed for the heating of the vehicle interior, thus suitably increasing driving distance and improving fuel efficiency.

In particular preferred embodiments of the present invention as described herein, since it is possible to cool the drive motor and at the same time assist the heating of the vehicle interior, it is possible to provide more efficient heating of the vehicle interior in the winter and improve the cooling efficiency of the drive motor.

Preferably, with the use of the single blower which leads to an increase in the weight and cost of the vehicle, it is possible to cool the drive motor, heat the vehicle interior using waste heat of the drive motor, and purify the air supplied to the vehicle interior at the same time. Therefore, it is possible to suitably reduce the number of parts and thus reduce the weight and the manufacturing cost of the vehicle.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An air conditioning system for an electric vehicle, the air conditioning system comprising:
a blower for blowing air;
a drive motor configured to receive the air blown by the blower;
an air purification system for purifying the air blown by the blower and supply the purified air to a vehicle interior;
a second valve for supplying the air blown by the blower to the drive motor and the air purification system, respectively; and
a third valve for supplying the air passing through the drive motor to the outside of the vehicle or to the air purification system,
wherein the air passing in turn through the drive motor and the air purification system is supplied to the vehicle interior, thus heating the vehicle interior.

2. The air conditioning system of claim 1, further comprising:
a heating system for heating the air purified by the air purification system and supplying the heated air to the vehicle interior; and
a fourth valve for supplying the air purified by the air purification system to the heating system and the vehicle interior, respectively,
wherein the air heated by the drive motor is further heated by the heating system and supplied to the vehicle interior.

3. The air conditioning system of claim 1, further comprising a bypass line branched from an air supply line, to which the air blown by the blower is supplied, and connected to the air purification system through the drive motor such that the air passing through the drive motor is supplied to the air purification system.

4. The air conditioning system of claim 3, further comprising a housing for surrounding the periphery of the drive motor, the housing having an interior space in which heat exchange between the drive motor and the air passing therethrough is made,
wherein the air flowing into the interior space of the housing through the bypass line at a front end of the drive motor absorbs heat generated from the drive motor and is discharged through the bypass line at a rear end of the drive motor.

5. The air conditioning system of claim 3, further comprising an air discharge line branched from the bypass line at the rear end of the drive motor such that the air passing through the drive motor is discharged to the outside of the vehicle.

6. A method for controlling an air conditioning system for an electric vehicle, the method comprising:
operating a blower for blowing air;
cooling a drive motor by supplying the air blown by the blower to the drive motor when the temperature of the drive motor is higher than a first predetermined reference temperature; and
heating a vehicle interior by supplying the air heated by the drive motor to the vehicle interior through an air purification system when the interior temperature of the vehicle is lower than a user's desired temperature.

7. The method of claim 6, further comprising supplying the air passing through the air purification system to a heating system during the heating of the vehicle interior such that the air further heated by the heating system is supplied to the vehicle interior.

8. The method of claim 6, wherein when it is determined that the heating of the vehicle interior is not required based on the interior temperature of the vehicle, the air heated by the drive motor is discharged to the outside of the vehicle through an air discharge line.

9. The method of claim 8, wherein when the interior temperature of the vehicle is higher than a second predetermined reference temperature, the outside air is supplied to the blower and the outside air blown by the blower is allowed to pass through the drive motor, thus cooling the drive motor by the outside air.

10. An air conditioning system for an electric vehicle, the air conditioning system comprising:
a blower for blowing air;
a drive motor;
an air purification system;
a second valve; and
a third valve,
wherein the air passing in turn through the drive motor and the air purification system is supplied to the vehicle interior, thus heating the vehicle interior.

11. The air conditioning system for an electric vehicle of claim 10, wherein the drive motor is configured to receive the air blown by the blower.

12. The air conditioning system for an electric vehicle of claim 10, wherein the air purification system is used for purifying the air blown by the blower and supply the purified air to a vehicle interior.

13. The air conditioning system for an electric vehicle of claim 10, wherein the second valve is used for supplying the air blown by the blower to the drive motor and the air purification system, respectively.

14. The air conditioning system for an electric vehicle of claim 10, wherein the third valve is used for supplying the air passing through the drive motor to the outside of the vehicle or to the air purification system.

15. A method for controlling an air conditioning system for an electric vehicle, the method comprising:
operating a blower for blowing air;
cooling a drive motor by supplying the air blown by the blower to the drive motor; and
heating a vehicle interior by supplying the air heated by the drive motor to the vehicle interior.

16. The method for controlling an air conditioning system for an electric vehicle of claim 15, wherein the drive motor is cooled when the temperature of the drive motor is higher than a first predetermined reference temperature.

17. The method for controlling an air conditioning system for an electric vehicle of claim 15, wherein the vehicle interior is heated through an air purification system when the interior temperature of the vehicle is lower than a user's desired temperature.
